(19) United States
(12) Patent Application Publication
(10) Pub. No.: US 2026/0021519 A1
(43) Pub. Date: Jan. 22, 2026

(54) AIR SAMPLER FOR DOWNDRAFT EQUIPMENT

(71) Applicant: DualDraw, LLC, Denver, CO (US)

(72) Inventors: Daniel B. PRATHER, Denver, CO (US); Peter CAREY, Denver, CO (US); Bevin N. SHARPE, Denver, CO (US)

(21) Appl. No.: 18/775,681

(22) Filed: Jul. 17, 2024

(51) Int. Cl. B08B 15/00; G01N 1/22; G01N 1/24

(52) U.S. Cl. CPC B08B 15/00; G01N 1/2247; G01N 1/24; G01N 2001/245

(57) ABSTRACT

Implementations disclosed herein provide a compact and easy-to-maintain piece of downdraft equipment for use in facilities with limited floor space that includes a unique air sampler to ascertain the state of dirty air entering the downdraft equipment. The air sampler utilizes a removable portable air quality detector that can be moved to further locate the source of a contaminant when detected. The portable air quality detector may also be replaced when defective without disassembling the downdraft equipment.

### BACKGROUND

Exposure to poor air in industrial facilities can affect the health and safety of employees. Downdraft equipment is used to collect dust, fumes, smoke, and particulates during certain industrial operations and applications. Downdraft equipment can provide air filtration and maintain air quality and control in a work environment.

### SUMMARY

Implementations disclosed herein provide a piece of downdraft equipment comprising a perforated work surface, a perforated rear wall, a dirty air intake plenum, a filter compartment, a filtration fan, and an air sampler. The air sampler includes a sampler intake with an input in the dirty air intake plenum, a sample plenum with a sample port, and a sampler fan that draws a sample of the dirty air from the sampler intake and discharges the dirty air sample into the sample plenum. The filtration fan draws dirty air from the perforated work surface and the perforated rear wall, through the dirty air intake plenum, and through the filter compartment. The filtration fan further exhausts filtered air out of the downdraft equipment. Implementations disclosed herein further provide a portable air quality detector that removably connects to the sample ports and provides a quality metric of the dirty air.

This Summary introduces a selection of concepts in a simplified form that are further described below in the Detailed Description. This Summary is not intended to identify key features or essential features of the claimed subject matter, nor is it intended to limit the scope of the claimed subject matter. Other features, details, utilities, and advantages of the claimed subject matter will be apparent from the following more particular written Detailed Description of various implementations as further illustrated in the accompanying drawings and defined in the appended claims.

### BRIEF DESCRIPTION OF THE DRAWINGS

FIG. 1 illustrates an exterior view of an example piece of downdraft equipment that incorporates an air sampler with a removable portable air quality detector.

FIG. 2 illustrates a sectional diagrammatic interior view of an example piece of downdraft equipment that incorporates an air sampler with a removable portable air quality detector.

FIG. 3 illustrates an example air sampler including a removable portable air quality detector installed in a piece of downdraft equipment.

FIG. 4 illustrates an example air sampler excluding a removable portable air quality detector for a piece of downdraft equipment.

FIG. 5 illustrates an interior of a sampler housing including a sampler fan for a piece of downdraft equipment.

FIG. 6 illustrates an exploded view of an example air sampler for a piece of downdraft equipment.

FIG. 7 illustrates a flowchart of example air filtering and sampling operations in an example piece of downdraft equipment.

### DETAILED DESCRIPTION

The disclosed technology includes downdraft equipment for industrial applications that require air filtration. Specifically, the downdraft equipment may include a compact, easy-to-maintain downdraft table, booth, or hood for use in facilities with limited floor space that includes a filter compartment and a filtration fan located beneath the work surface. As the air entering the downdraft equipment may contain a variety of contaminants, it may be useful or necessary to provide some feedback to a user as to the state of the incoming air, particularly if a harmful contaminant is detected. As such, the downdraft equipment includes an air sampler to ascertain the state of dirty air entering the downdraft equipment. The air sampler utilizes a removable portable air quality detector that in some implementations can be moved to further locate the source of a contaminant when detected. The portable air quality detector may also be replaced when defective without disassembling the downdraft equipment.

Dirty air and clean air are terms used herein to reference the state of an airflow upstream of the filter compartment (i.e., dirty air) and downstream of the filter compartment (i.e., clean air). Dirty air and clean air are not used herein to define an actual state of cleanliness of the air, as that may vary widely in application. In various implementations, the downdraft equipment may also include a spark arrestor for fire protection, one or more removable clean-out trays for particulate collection, and a louver for one-way airflow, for example. All of the aforementioned components may be located in a main housing of the downdraft equipment.

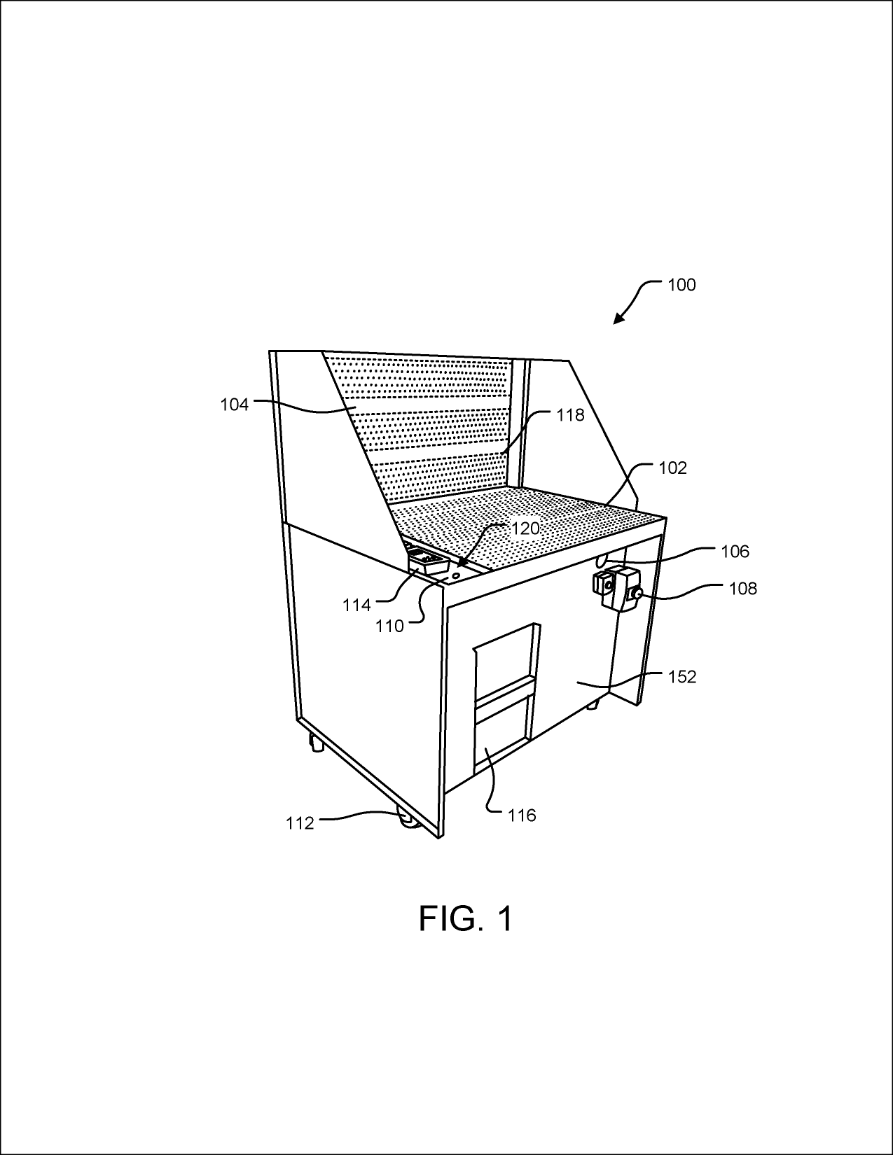

FIG. 1 illustrates an exterior view of an example piece of downdraft equipment 100 that incorporates an air sampler tray 120 with a removable portable air quality detector 114. The downdraft equipment 100 is generally used to collect ambient air near the downdraft equipment 100 and filter that air before it is discharged back into the atmosphere. This can vastly improve air quality in the vicinity of the downdraft equipment 100, particularly for operators that are working near the downdraft equipment 100, including operators that are using the downdraft equipment 100 as a table or work surface. In some implementations, the downdraft equipment 100 includes caster wheels (e.g., wheel 112) that permit operators to move and position the downdraft equipment 100 as desired.

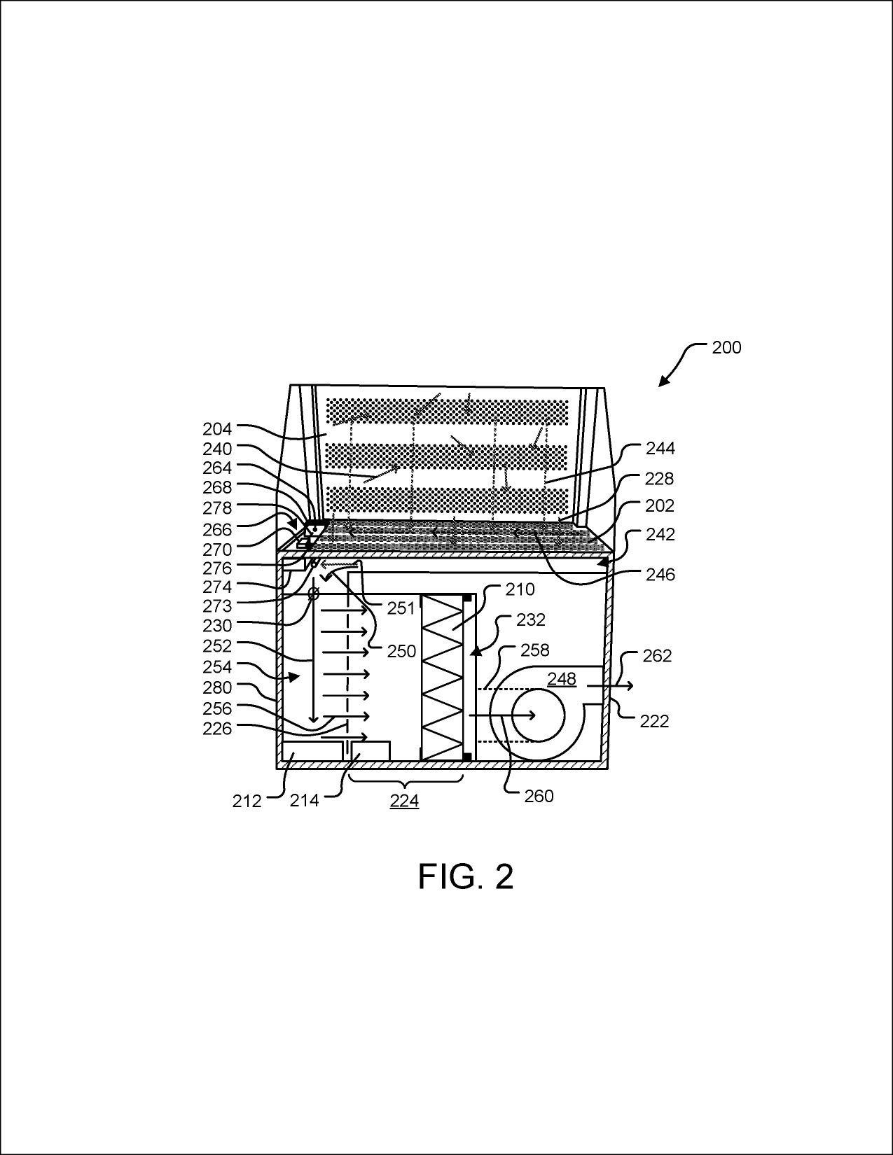

The downdraft equipment 100 functions by pulling air through a perforated work surface 102 and/or a perforated rear wall 104. Thus, air in FIG. 1 can be pulled downward and/or rearward through the perforated holes into the downdraft equipment 100 by a filtration fan (not shown, see e.g., filtration fan 248 of FIG. 2), which is located below the perforated work surface 102. The perforations may be consistently spaced (e.g., as illustrated on the perforated work surface 102) or have some variation in pattern (e.g., as illustrated on the perforated rear wall 104). In other implementations, for example in an air filtration system, air can be pulled through an intake, panel, nozzle, or other entryway aside from the perforated work surface 102 and/or the perforated rear wall 104.

The downdraft equipment 100 has one or both of downdraft and backdraft airflow, via the perforations or perforated holes in the perforated work surface 102 and/or the perforated rear wall 104. The perforations can vary in size and shape; for example, the perforations can be 1/2”x 3/16” or 1/2”x3/8” rectangular holes in 16GA thick material. For further example, the perforations can be 3/16”, 3/8”, or 1/2” diameter circular holes in 1/2” thick material. In some implementations, the perforations are arranged on multiple grates that make up the perforated work surface 102 and/or the perforated rear wall 104. For example, the perforations may be configured into removable grates, such as removable grate 118 (illustrated by an area of uniformly distributed perforations bounded by parallel broken lines). These grates may be 5” wide, 1” thick, and span the length of the work surface (e.g., 36”, 48”, 60”, 72”, etc. long), for example. Other work surface configurations are contemplated. The vacuum of the filtration fan in the downdraft equipment 100 provides even dispersion of negative air pressure and a resulting inward airflow over the perforated work surface 102 and/or the perforated rear wall 104 of the downdraft equipment 100.

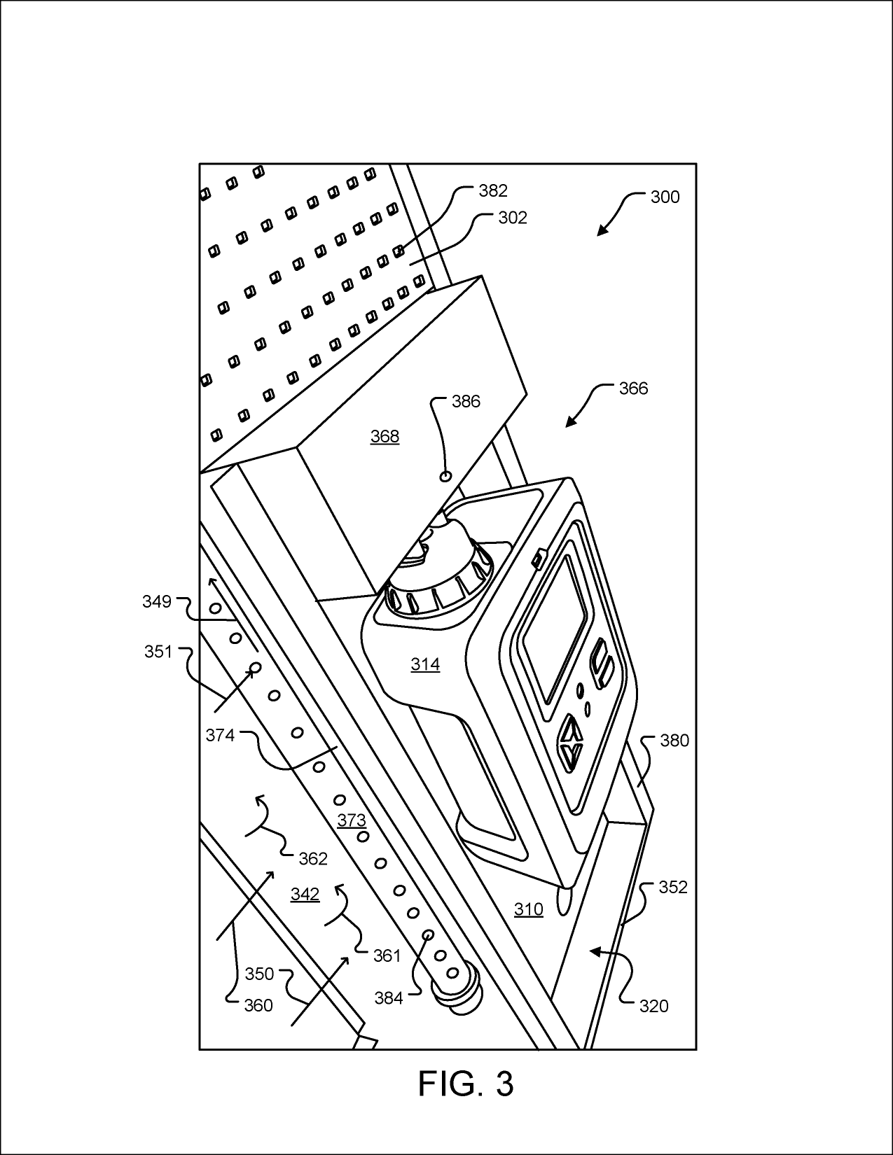

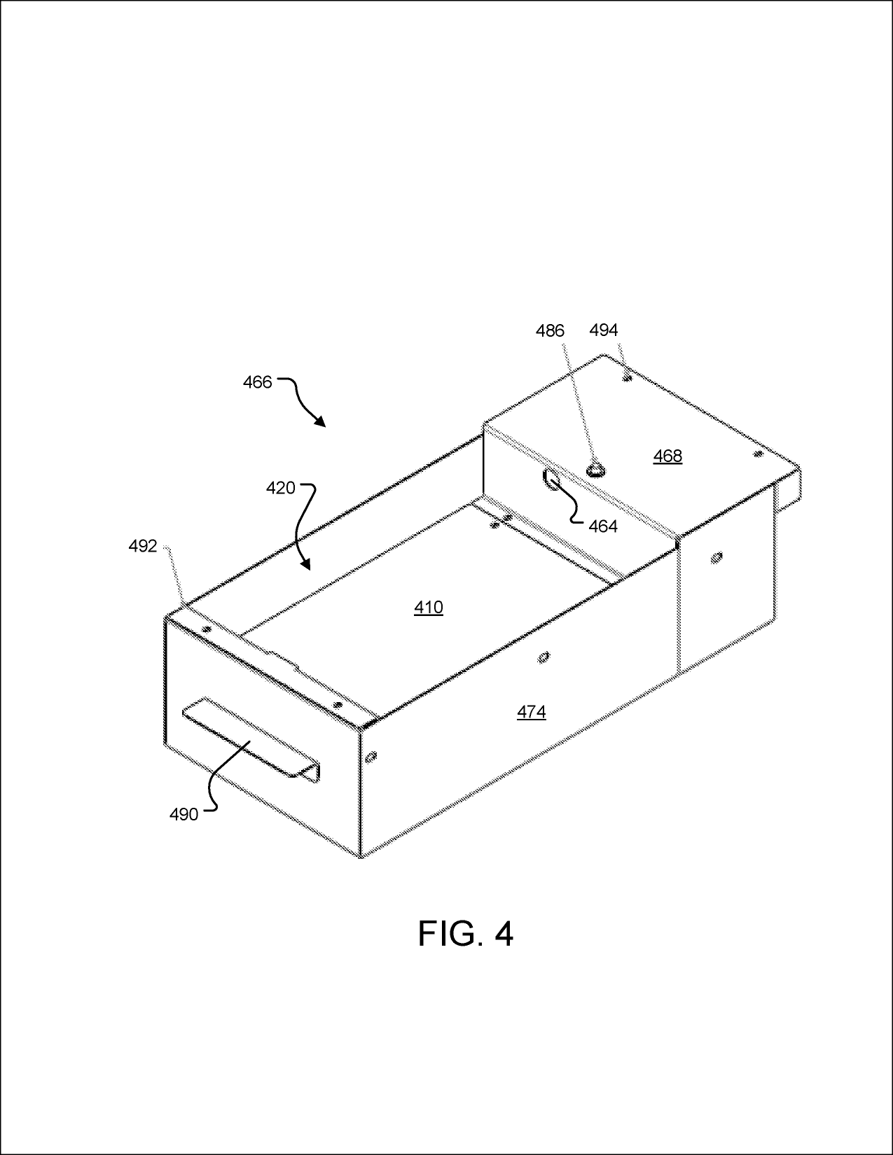

The perforated work surface 102 includes a blanked-off and recessed portion that serves as the air sampler tray 120. The air sampler tray 120 is illustrated on a left side and near a front of the perforated work surface 102; however, other implementations may locate the air sampler tray 120 elsewhere adjacent to the perforated work surface 102 (e.g., the air samplers 366, 466 of FIGS. 3 and 4, respectively, are illustrated on a right side). The air sampler tray 120 is sized to house the portable air quality detector 114 that is removably connected to a sample port (not shown, see e.g., sample port 264 of FIG. 2). The air sampler tray 120 includes a removable access panel 110 that conceals a sampler housing (not shown, see e.g., sampler housing 274 of FIG. 2). The portable air quality detector 114 rests on the removable access panel 110 when closed, as illustrated in FIG. 1.

The portable air quality detector (or identifier) 114 provides a quality metric of the dirty air pulled through the perforated work surface 102. The quality metric may be directed to the presence and/or quantity of gaseous components and/or liquid / solid particulate matter entrained within the dirty air. For example, the quality metric includes the presence of one or more of: pathogens, volatile organic compounds (VOCs), carbon monoxide (CO), poisonous compounds, explosives, or psychoactive drugs (including, but not limited to opioids (natural and synthetic), such as fentanyl), all referenced against a threshold. If the detected quantity exceeds a corresponding threshold, a user of the downdraft equipment 100 is audibly and/or visually alerted via the portable air quality detector 114. The user may take a variety of remedial steps, including but not limited to shutting the downdraft equipment 100 down, removing the portable air quality detector 114 from the air sampler tray 120, and using its input port to locate a source of the detected offending gaseous components and/or liquid / solid particulate matter.

The downdraft equipment 100 will have a power supply appropriate for the power needs of the downdraft equipment 100, including but not limited to a motor driving the filtration fan, a sampler fan, and various sensors and controls for the downdraft equipment 100. The downdraft equipment 100 may be configured for single-phase (115V/230V) or three-phase (208-230V/460V) power, for example. The controls (e.g., an on/off switch 108, a pressure gauge 106, etc.) are located on a front panel 152 of the downdraft equipment 100. In other implementations, the controls may be located in different areas of the downdraft equipment 100. The on/off switch 108 selectively powers the motor driving the filtration fan that pulls air from the perforated work surface 102 and/or the perforated rear wall 104 down into the downdraft equipment 100 and out through an exhaust (not shown) in the back of the downdraft equipment 100 when in an “ON” state. The controls may be housed in a NEMA 12/4X enclosure and contain thermal protection that protects an operator from electrical issues.

As vacuum builds up in the downdraft equipment 100, the pressure gauge 106 measures the air pressure and indicates to the operator if and when the vacuum meets a predetermined differential pressure threshold. In some implementations, the predetermined differential pressure threshold can be a static reading. The pressure gauge 106 provides the operator with an indication of the cleanliness of an internal filter insert (not shown, see e.g., filter insert 210 of FIG. 2), as a dirty filter insert will cause a vacuum pressure to exceed the differential pressure threshold. Through this feedback, the operator will decide, based on the indication of the pressure gauge 106, when to clean or replace the filter insert.

As air, including suspended particulates, is pulled from the exterior of the downdraft equipment 100, it moves downward and towards the left interior side of the downdraft equipment 100, for example. This example general airflow direction is depicted in FIG. 2. In other implementations, airflow can move in other general directions (e.g., right, front, or back). In some implementations, the air moves through a spark arrestor (not shown, see e.g., spark arrestor 226 of FIG. 2) located under the perforated work surface 102 on the left interior side of the downdraft equipment 100 between the filter insert and the perforated work surface 102. The spark arrestor adds protection against applications that may create sparks or an increased risk of a fire, such as welding, grinding metal, or plasma cutting. The air moves through the spark arrestor downward in the downdraft equipment 100. Then it moves toward the center of the downdraft equipment 100 into a filter compartment (not shown, see e.g., filter compartment 224 of FIG. 2) that houses the filter insert.

As the air moves through the filter insert, particulates suspended within the air fall out of the airflow via gravity into one or more removable clean-out trays (not shown, see e.g., trays 212, 214 of FIG. 2) or attach to filter media within the filter insert before being ingested into the filtration fan and exhausted out of an exhaust port (not shown, see e.g., exhaust port 222 of FIG. 2) located on a side, rear, or bottom panel of the downdraft equipment 100. In various implementations, the exhaust port may be a perforated area, an area of expanded metal, or a vent pipe on any outside-facing panel of the downdraft equipment 100. In some implementations, particulate is precluded from blow-back towards the operator by a one-way self-closing louver (not shown, see e.g., louver 230 of FIG. 2) that allows dirty air to move through the downdraft equipment 100 in only one direction, thus preventing reverse airflow through the perforated work surface 102 and/or the perforated rear wall 104 and protecting the operator from potential particulate blow-back.

The filter insert in the downdraft equipment 100 may be designed to address applications that produce dust or fumes continuously. The operator can observe the pressure gauge 106 to help determine the cleanliness of the filter insert. The pressure gauge 106 measures the differential pressure, or pressure drop, across the filter insert. When the filter insert has met the predetermined differential pressure threshold and needs to be cleaned or replaced, a notification system can send a signal to alert the operator. The threshold can be a specific pressure range indicating sufficient particulates have accumulated on the filter insert to restrict airflow.

Access door 116, depicted on the front panel 152 of the downdraft equipment 100, provides access to the filter compartment, including the filter insert and the removable clean-out trays. The downdraft equipment 100 may have different or additional access doors to that depicted in FIG. 1. For example, another door may be located on the non-depicted side of the downdraft equipment 100 for access to a right-side interior of the downdraft equipment 100 for maintenance (e.g., access to the filtration motor, filtration fan, etc.).

The downdraft equipment 100 can be a modular design tailored to desired applications, sizes, and operator requirements. For example, the following downdraft tables with the perforated work surface 102 and the perforated rear wall 104 can be configured for approximately 2000 CFM, 30”D X 48”W X 58”H; 2500 CFM, 30”D X 60”W X 58”H; 3000 CFM, 30”D X 72”W X 58”H; 4000 CFM, 30”D X 96”W X 58”H; 2000 CFM, 30”D X 48”W X 80”H; 2500 CFM, 30”D X 48”W X 80”H; 3000 CFM, 30”D X 48”W X 80”H; or 4000 CFM, 30”D X 48”W X 80”H. For further example, the following flat top downdraft tables with the perforated work surface 102 only can be configured for approximately 2000 CFM, 30”D X 48”W X 34”H; 2500 CFM, 30”D X 48”W X 34”H; 3000 CFM, 30”D X 48”W X 34”H; or 4000 CFM, 30”D X 48”W X 34”H. Still further, depth of the downdraft tables may be customized using regular increments, such as 5” (e.g., 35”, 40”, 45”, 50”, 55”, and 60”). The foregoing are examples as other configurations and sizes of the downdraft equipment 100 are contemplated herein.

FIG. 2 illustrates a sectional diagrammatic interior view of an example piece of downdraft equipment 200 that incorporates an air sampler 266 to removably interface with a portable air quality detector (not shown, see e.g., portable air quality detector 114). Air, including suspended particulates, or “dirty air,” is shown moving from a perforated work surface 202 and a perforated rear wall 204 into the interior of the downdraft equipment 200 to a filter insert 210 using a variety of arrows. Filtered air or “clean air” is shown exiting the filter insert 210, drawn through a filtration fan 248, and exhausted from the downdraft equipment 200 via an exhaust port 222 using additional arrows. This general air movement through the downdraft equipment 200 is described in detail below.

The dirty air is generated above the perforated work surface 202 (a horizontally oriented surface) and near an operator of the downdraft equipment 200. This air may harm the operator’s respiratory health and is thus drawn through holes in the perforated work surface 202, away from the operator, and into the downdraft equipment 200, as illustrated by downwardly directed solid arrows (e.g., solid downward arrow 228). The air is further drawn through holes in the perforated rear wall 204 (a vertically oriented surface), away from the operator, and into the downdraft equipment 200, as illustrated by randomly directed solid arrows (e.g., arrow 240).

The dirty air is pulled downward and rearward through the perforated holes into the downdraft equipment 200 by filtration fan 248, located below the perforated work surface 202. A static vacuum supplied by the filtration fan 248 on the perforated work surface 202 and the perforated rear wall 204 provides for an even dispersion of airflow over the work surface 202 and the perforated rear wall 204 into the downdraft equipment 200. In some implementations, the perforated rear wall 204 is omitted from the downdraft equipment 200, and all the airflow flows through the perforated work surface 202 into the downdraft equipment 200.

The dirty air is further directed downward into a dirty air intake plenum 242, as illustrated by downwardly directed broken arrows (e.g., downward broken arrow 244), and to the left within the dirty air intake plenum 242, as illustrated by leftward directed broken arrows (e.g., leftward broken arrow 246). In other implementations, airflow can be moved in another direction (e.g., rightward, frontward, or backward) within the dirty air intake plenum 242. The dirty air moves in the leftward direction within the dirty air intake plenum 242 and then downward into a vertical chute 254, as illustrated by arrows 250, 252. In other implementations, there may be different configurations of compartments, chutes, and pathways for the dirty air within the downdraft equipment 200.

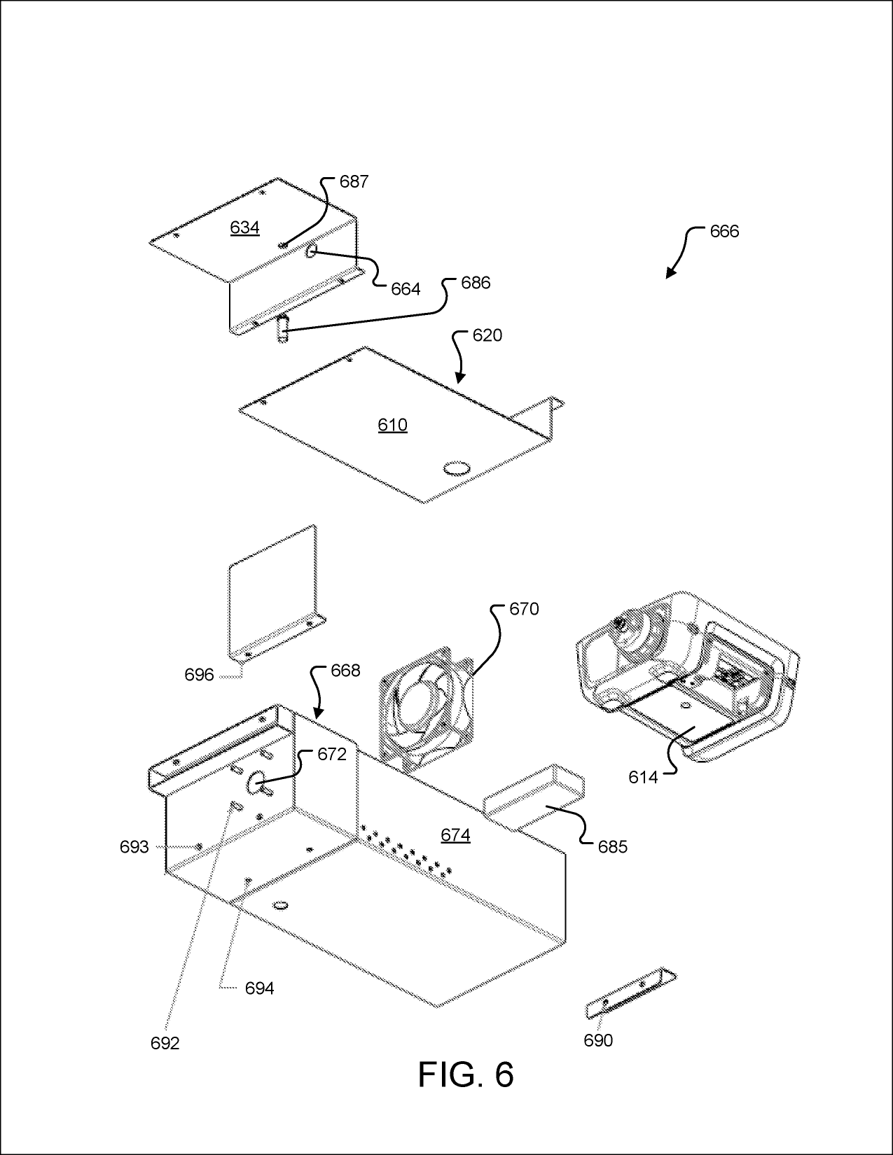

The air sampler 266 is used to ascertain one or more quality metrics of the dirty air directed through the dirty air intake plenum 242. This may protect a user of the downdraft equipment 200 from harmful contaminants in the dirty air by alerting the user to the presence of the contaminants in sufficient concentration within the dirty air to be a cause of concern. To do this, the portable air quality detector is removably connected to sample port 264 in sample plenum 268. The sample plenum 268 is under a slight positive pressurization (e.g., less than 1psi) provided by a sampler fan 270 discharging dirty air into the sample plenum 268. The sampler fan 270 draws a sample of the dirty air from a sampler intake (not shown, see e.g., sampler intake 672 of FIG. 6) via a sampler intake pipe 273, as illustrated by arrow 251, which at least in part resides within the dirty air intake plenum 242 and has at least one input within the dirty air intake plenum 242.

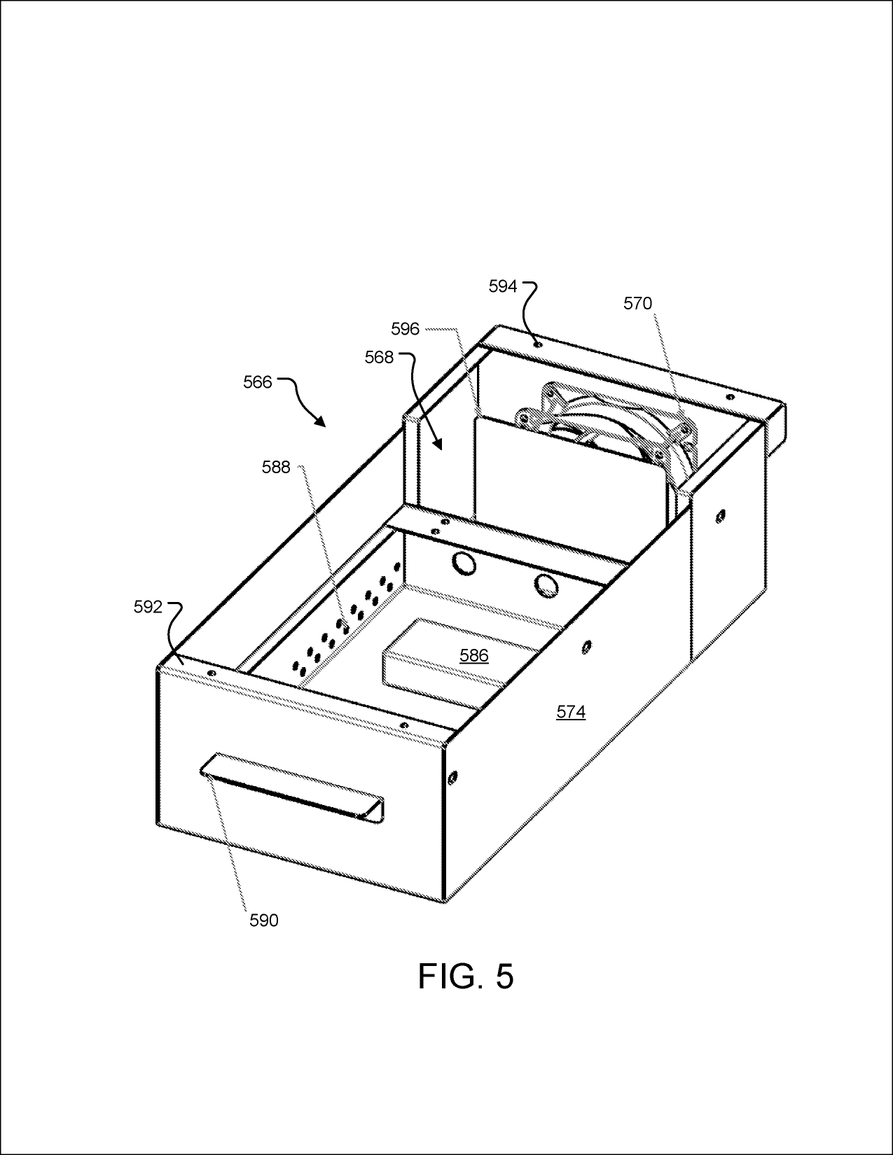

The sampler fan 270 resides within a sampler housing 274 below the perforated work surface 202 within the downdraft equipment 200. A sampler fan intake plenum 276 connects the sampler intake to the sampler fan 270 and/or a portion of the sampler intake itself may also be included within the sampler housing 274. Similarly, the sampler fan outlet plenum 278 connects the sample plenum 268 to the sampler fan 270. A portion of the sample plenum 268 itself may also be included within the sampler housing 274. Further, a power supply (not shown, see e.g., power supply 586 of FIG. 5) for the sampler fan 270 or other powered components of the downdraft equipment 200 and/or other components for the air sampler 266 or the downdraft equipment 200 may also be included within the sampler housing 274.

The sampler housing 274 is illustrated with a removable access panel (not shown, see e.g., removable access panel 110 of FIG. 1) removed. When in place, the removable access panel covers the sampler fan 270 and other components within the sampler housing 274, if present. Further, the removable access panel serves as a bottom of an air sampler tray (also not shown, see e.g., air sampler tray 120 of FIG. 1), and a rear of the air sampler tray is defined by the sample plenum 268. The sides and front of the air sampler tray are defined by ends of the removable grates (not shown, see e.g., removable grate 118 of FIG. 1) making up the perforated work surface 202, a side panel 280, and a front panel (not shown, see e.g., front panel 152 of FIG. 1) of the downdraft equipment 200. When closed within the air sampler tray, the portable air quality detector rests on the removable access panel.

The dirty air is precluded from reverse airflow through the perforated work surface 202 and/or the perforated rear wall 204 and blow-back towards the operator by a one-way self-closing louver 230 that allows dirty air to move through the downdraft equipment 200 in only one direction, thus protecting the operator from potential blow-back of particulate-entrained air. The one-way self-closing louver 230 is at the top of the vertical chute 254. In other implementations, the one-way self-closing louver 230 is omitted if the risk of blow-back is considered low or negligible. The dirty air moves through a spark arrestor 226 located at one side of the vertical chute 254 between the filter insert 210 and the one-way self-closing louver 230, as illustrated by rightward directed solid arrows (e.g., rightward solid arrow 256). The spark arrestor 226 adds protection against applications that may create sparks or an increased risk of a fire, such as welding, grinding metal, or plasma cutting.

The bottom of the vertical chute 254 may include removable clean-out trays 212, 214. Particulate matter that falls out of the dirty airflow, mainly as it passes through the spark arrestor 226, falls into the removable clean-out trays 212, 214. In other implementations, the downdraft equipment 200 may have greater or fewer removable clean-out trays and the removable clean-out trays may be located differently than depicted in FIG. 2. For example, a first tray may be adjacent to a bottom of the spark arrestor 226, and a second tray may be adjacent to a bottom of the filter insert 210 to collect particulate matter. Removing the clean-out trays does not require removing the filter insert 210 or any other unit disassembly beyond removing an access door (not shown, see e.g., access door 116 of FIG. 1).

The dirty air moves downward through the one-way self-closing louver 230, rightward through the spark arrestor 226, and then toward a center of the downdraft equipment 200 into a filter compartment 224 that houses a filter insert 210. As air moves through the filter insert 210, particulates attach to the filter insert 210. Once the dirty air permeates the filter, “clean” air is drawn into a fan plenum 232 and subsequently fan inlet 258, as illustrated by arrow 260. An exhaust port 222 is located in the side panel of the downdraft equipment 200, and air exits from the filtration fan 248 out of the downdraft equipment 200 at the exhaust port 222, as illustrated by arrow 262. In other implementations, the exhaust port 222 may be vented out of a different panel of the downdraft equipment 200 (e.g., a rear or bottom panel).

The construction, size, and configuration of the filter insert 210 in the downdraft equipment 200 matches the intended application, including but not limited to those continuously producing large amounts of dust or fumes. In an example implementation, the filter insert 210 includes a 24”x24”x2” activated carbon filter that filters VOCs and other odor-causing substances from the dirty air. An operator can observe a pressure gauge (not shown, see e.g., pressure gauge 106 of FIG. 1) mounted on an exterior panel of the downdraft equipment 200 facing the operator to help determine the cleanliness of the filter insert 210. The pressure gauge measures the differential pressure across the filter insert 210. A differential pressure greater than a predetermined threshold value indicates that air is blocked by the dirty filter insert 210 and should be cleaned or replaced. When the filter insert 210 has met the predetermined differential pressure threshold and needs to be cleaned or replaced, a notification system can send a signal to alert the operator. The threshold can be a specific pressure range indicating sufficient particulates have accumulated on the filter to render the airflow insufficient for efficient operation of the downdraft equipment 200.

FIG. 3 illustrates an example air sampler 366 including a removable portable air quality detector 314 installed in a piece of downdraft equipment 300 (illustrated in part). Air, including suspended particulates, or “dirty air,” moves from a perforated work surface 302 and a perforated rear wall (not shown, see e.g., perforated rear wall 204 of FIG. 2), if present, into the interior of the downdraft equipment 300 to a filter insert (not shown, see e.g., filter insert 210 of FIG. 2). Filtered air or “clean air” exits the filter insert and is exhausted from the downdraft equipment 300. This general air movement through the downdraft equipment 300 may be as described above with reference to FIG. 2.

The dirty air is generated above the perforated work surface 302 (a horizontally oriented surface) and near the downdraft equipment 300 operator. This air may harm the operator’s respiratory health and is thus drawn through the holes (e.g., hole 382) in the perforated work surface 302, away from the operator, and into the downdraft equipment 300. The air may also be drawn through similar or different holes in the perforated rear wall (a vertically oriented surface), if present, also away from the operator and into the downdraft equipment 300.

The dirty air is directed downward into a dirty air intake plenum 342 and then further downward into a vertical chute (not shown, see e.g., vertical chute 254 of FIG. 2), as illustrated by arrows 350, 360, 361, 362. In other implementations, there may be different configurations of compartments, chutes, and pathways for the dirty air within the downdraft equipment 300. Grates forming the perforated work surface 302 to the left of air sampler tray 320 in FIG. 3 are omitted to illustrate the dirty air intake plenum 342 and a sampler intake pipe 373, discussed in further detail below.

The air sampler 366 is used to ascertain one or more quality metrics of the dirty air directed through the dirty air intake plenum 342. This may protect a user of the downdraft equipment 300 from harmful contaminants in the dirty air by alerting the user to the presence of the contaminants in sufficient concentration within the dirty air to be a cause of concern. To do this, the portable air quality detector 314 is removably connected to a sample port (not shown, see e.g., sample port 464 of FIG. 4) in a sample plenum 368. The sample plenum 368 is under a slight positive pressurization (e.g., less than 1psi) provided by a sampler fan (not shown, see e.g., sampler fan 570 of FIG. 5) discharging dirty air into the sample plenum 368. The sampler fan draws a sample of the dirty air from a sampler intake (not shown, see e.g., sampler intake 672 of FIG. 6), as illustrated by arrows 349, 351, which is connected to a sampler intake pipe 373. The intake pipe 373 at least in part resides within the dirty air intake plenum 342 and has at least one input within the dirty air intake plenum 342.

The sampler intake pipe 373 is a multi-port intake manifold that extends across the dirty air intake plenum and includes a spaced array of input holes (e.g., input hole 384). This structure and arrangement of input holes allows for a dirty air sample to be taken across a depth of the dirty air intake plenum 342, potentially yielding a more accurate representation of the dirty air flowing through the dirty air intake plenum 342. The sampler intake pipe 373 extends out of view to sampler housing 374 and connects to the sampler fan at the sampler intake. In other implementations, the sampler intake pipe 373 may take various alternative forms so long as there is at least one input within the dirty air intake plenum 342.

The sampler housing 374 includes a removable access panel 310 that, when in place (as illustrated in FIG. 3), covers a power supply and other components within the sampler housing 374, if present. Further, the removable access panel 310 serves as a bottom of the air sampler tray 320. A rear of the air sampler tray 320 is defined by the sample plenum 368, and the sides and front of the air sampler tray are defined by ends of the removable grates making up the perforated work surface 202, a side panel 380, and a front panel 352 of the downdraft equipment 300. As illustrated, the portable air quality detector 314 rests on the removable access panel 310 when closed within the air sampler tray 320.

In some implementations, the downdraft equipment 300 includes an indicator light 386 on a visible surface of the sample plenum 368. The indicator light 386 communicates to a user that the sampler fan is running. This may be especially important in noisy environments as the sampler fan may not be audible, and there may be no other indication that the air sampler 366 is operating while the downdraft equipment 300 is being used.

FIG. 4 illustrates an example air sampler 466 excluding a removable portable air quality detector (see e.g., portable air quality detector 314) for a piece of downdraft equipment (not shown, see e.g., downdraft equipment 200 of FIG. 2). The air sampler 466 is used to ascertain one or more quality metrics of the dirty air directed through a dirty air intake plenum (not shown, see e.g., dirty air intake plenum 342 of FIG. 3) within the downdraft equipment. This may protect a user of the downdraft equipment from harmful contaminants in the dirty air by alerting the user to the presence of the contaminants in sufficient concentration within the dirty air to be a cause of concern.

To do this, the portable air quality detector is removably connected to a sample port 464 in a sample plenum 468 of the air sampler 466. The sample plenum 468 is under a slight positive pressurization (e.g., less than 1psi) provided by a sampler fan (not shown, see e.g., sampler fan 570 of FIG. 5) discharging dirty air into the sample plenum 468. The sampler fan draws a sample of the dirty air from a sampler intake that is connected to the dirty air intake plenum via a sampler intake pipe (not shown, see e.g., sampler intake pipe 373 of FIG. 3).

The air sampler 466 includes a generally rectangular sampler housing 474 that includes the sample plenum 468, an air sampler tray 420, and an electrical compartment (not shown, see e.g., electrical compartment 588 of FIG. 5). A removable access panel 410, when in place (as illustrated in FIG. 4), covers a power supply (not shown, see e.g., power supply 586 of FIG. 5) and other components within the electrical compartment, if present. Further, the removable access panel 410 serves as a bottom of the air sampler tray 420. A rear of the air sampler tray 420 is defined by the sample plenum 468, and the sides and front of the air sampler tray 420 are defined by upturned portions of the sampler housing 474. The portable air quality detector rests on the removable access panel 410 when closed within the air sampler tray 420.

The sampler housing 474 may further include an array of mounting brackets (e.g., bracket 490), flanges (e.g., flange 492), and screw holes (e.g., screw hole 494) for assembling the sampler housing 474 and mounting the sampler housing 474 within the piece of downdraft equipment. While example mounting brackets, flanges, and screw holes are shown, other implementations may vary widely. The sampler housing 474 may also include an indicator light 486 on a visible surface of the sample plenum 468. The indicator light 486 may communicate to a user that the sampler fan is running.

FIG. 5 illustrates an interior of a sampler housing 574 for an air sampler 566 including a sampler fan 570 for a piece of downdraft equipment (not shown, see e.g., downdraft equipment 200 of FIG. 2). The air sampler 566 is used to ascertain one or more quality metrics of the dirty air directed through a dirty air intake plenum (not shown, see e.g., dirty air intake plenum 342 of FIG. 3) within the downdraft equipment. This may protect a user of the downdraft equipment from harmful contaminants in the dirty air by alerting the user to the presence of the contaminants in sufficient concentration within the dirty air to be a cause of concern.

To do this, a portable air quality detector (not shown, see e.g., portable air quality detector 314 of FIG. 3) is removably connected to a sample port (not shown, see e.g., sample port 464 of FIG. 4) in a sample plenum 568. A fan cover (not shown, see e.g., fan cover 634 of FIG. 6) is removed in FIG. 5 to illustrate the interior of the sample plenum 568. The sample plenum 568 is under a slight positive pressurization (e.g., less than 1psi) provided by the sampler fan 570 therein discharging dirty air directly into the sample plenum 568. A fan baffle 596 may be included within the sample plenum 568 in front of the sampler fan 570 to prevent the sampler fan 570 from blowing directly on the sample port. The sampler fan 570 draws a sample of the dirty air from a sampler intake (not shown, see e.g., sampler intake 672 of FIG. 6). The sampler intake is connected to a sampler intake pipe (also not shown, see e.g., sampler intake pipe 373 of FIG. 3), which at least in part, resides within the dirty air intake plenum of the downdraft equipment. In other implementations, the sampler fan 570 resides within the sampler housing 574 below the perforated work surface within the downdraft equipment.

A removable access panel (not shown, see e.g., removable access panel 410 of FIG. 4) is removed in FIG. 5 to illustrate the interior of electrical compartment 588. When in place, the removable access panel covers the power supply 586 and other components within the electrical compartment 588, if present. Further, the removable access panel serves as a bottom of an air sampler tray (also not shown, see e.g., air sampler tray 320 of FIG. 3). The portable air quality detector rests on the removable access panel when closed within the air sampler tray. The sampler housing 574 may further include an array of mounting brackets (e.g., bracket 590), flanges (e.g., flange 592), and screw holes (e.g., screw hole 594) for assembling the sampler housing 574 and mounting the sampler housing 574 within the piece of downdraft equipment.

The electrical compartment 588 includes power supply 586 for the sampler fan 570, the portable air quality detector, or other powered components of the downdraft equipment and/or other components for the air sampler 566 or the downdraft equipment may also be included within the electrical compartment 588. The power supply 586 ensures that the air sampler 566, including the portable air quality detector and the sampler fan 570, are powered as long as the downdraft equipment is powered. In various implementations, a fluid path for the dirty air that passes through the sampler intake, the sampler fan 570, and into the sample plenum 568 is generally contained within the sample plenum 568. Therefore, the electrical compartment 588 and the air sampler tray may be kept relatively clean and remain accessible even when the downdraft equipment and air sampler 566 are in operation.

FIG. 6 illustrates an exploded view of an example air sampler 666 for a piece of downdraft equipment (not shown, see e.g., downdraft equipment 200 of FIG. 2). The air sampler 666 is used to ascertain one or more quality metrics of the dirty air directed through a dirty air intake plenum (not shown, see e.g., dirty air intake plenum 342 of FIG. 3) within the downdraft equipment. This may protect a user of the downdraft equipment from harmful contaminants in the dirty air by alerting the user to the presence of the contaminants in sufficient concentration within the dirty air to be a cause of concern.

The air sampler 666 includes a generally rectangular sampler housing 674 that includes the sample plenum 668, an air sampler tray 620, and an electrical compartment (not shown, see e.g., electrical compartment 588 of FIG. 5). A fan cover 634, when in place (as illustrated in FIG. 4), covers a sampler fan 670, a fan baffle 696, and other components within the sample plenum 668, if present. A removable access panel 610, when in place (as illustrated in FIG. 4), covers a power supply 685 and other components within the electrical compartment, if present.

The removable access panel 610 serves as a bottom of the air sampler tray 620. A rear of the air sampler tray 620 is defined by the fan cover 634, the sides of the air sampler tray 620 are defined by upturned portions of the sampler housing 674, and the front of the air sampler tray 620 is defined by an upturned portion of the removable access panel 610. The portable air quality detector 614 rests on the removable access panel 610 and within the air sampler tray 620.

The portable air quality detector 614 is removably connected to a sample port 664 in the fan cover 634 and into the sample plenum 668. The sample plenum 668 is under a slight positive pressurization provided by the sampler fan 670 therein discharging dirty air directly into the sample plenum 668. The fan baffle 696 prevents the sampler fan 670 from blowing directly on the sample port 664. The sampler fan 670 draws a sample of the dirty air from a sampler intake 672, which is connected to a sampler intake pipe (also not shown, see e.g., sampler intake pipe 373 of FIG. 3), which at least in part, resides within the dirty air intake plenum of the downdraft equipment.

The sampler housing 674 may further include an array of mounting brackets (e.g., bracket 690), studs (e.g., stud 692), and screw holes (e.g., screw holes 693, 694) for assembling the sampler housing 674 and mounting the sampler housing 674 within the piece of downdraft equipment. While example mounting brackets, flanges, and screw holes are shown, other implementations may vary widely. The sampler housing 674 may also include an indicator light 686 that protrudes through (or is visible through) light hole 687 in the fan cover 634. The indicator light 486 may communicate to a user that the sampler fan is running.

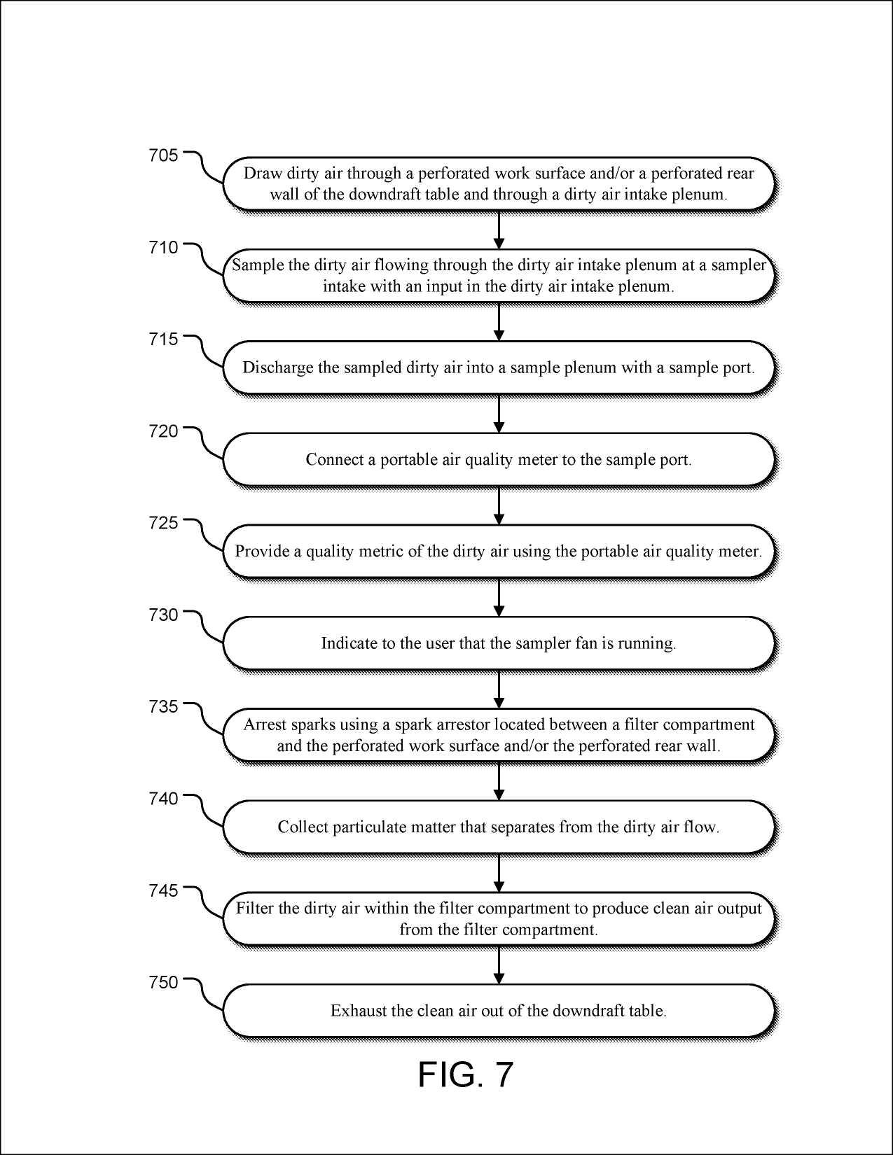

FIG. 7 illustrates a flowchart of example air filtering and sampling operations in an example piece of downdraft equipment. The downdraft equipment includes an integrated air sampler explicitly directed to the air sampling operations 710, 715, 720, 725, and 730 that are generally used to detect and notify a user if and when dirty air flowing through the downdraft equipment fails one or more quality metrics.

A drawing operation 705 draws dirty air through one or more perforated surfaces (e.g., a perforated work surface or a perforated rear wall) of the downdraft equipment, through a dirty air intake plenum, and through a filter compartment using a filtration fan. The filtration fan provides a static vacuum in the downdraft equipment to evenly disperse airflow through the perforated work surface and/or rear wall. Thus, the dirty air can be pulled downward, rearward, and/or horizontally through the perforated holes into the downdraft equipment by the filtration fan, which is located within the downdraft equipment behind the filter insert. After passing through the filter compartment, the dirty air becomes clean air, and the filtration fan discharges the clean air from the downdraft equipment via an exhaust port.

A sampling operation 710 samples the dirty air flowing through the dirty air intake plenum at a sampler intake with an input in the dirty air intake plenum. A discharging operation 715 discharges the sampled dirty air into a sample plenum with a sample port. A sampler fan provides a vacuum to pull the dirty air sample through the sampler intake and a positive output pressure to push the dirty air sample into the sample plenum. The sampler fan maintains the sample plenum at a positive pressure so that the sample plenum remains filled with an accurate representation of the dirty air within the dirty air intake plenum.

A connecting operation 720 removably connects a portable air quality detector to the sample port. In various implementations, the portable air quality detector includes an input port that is interfaced with or inserted into the sample port in the sample plenum. A providing operation 725 provides the quality metric of the dirty air using the portable air quality detector. The quality metric may be directed to the presence and quantity of gaseous components and/or liquid / solid particulate matter entrained within the dirty air. For example, the quality metric includes the presence of one or more of: pathogens, VOCs, CO, poisonous compounds, explosives, or psychoactive drugs, all referenced against a threshold. If the detected quantity exceeds a corresponding threshold, a user of the downdraft equipment is audibly and/or visually alerted. An indicating operation 730 visually indicates to the user that the sampler fan is running, thereby communicating that the air sampler is in use. This may be especially important in noisy environments as the sampler fan may not be audible, and there may be no other indication that the air sampler is operating while the downdraft equipment is being used.

An arresting operation 735 arrests sparks using a spark arrestor located between the filter insert and the perforated work surface and/or the perforated rear wall. The spark arrestor arrests sparks as air is drawn through the downdraft equipment. The spark arrestor adds protection against applications that may create sparks or an increased risk of a fire, such as welding, grinding metal, or plasma cutting. Dirty air may move through the spark arrestor downward in the downdraft equipment and then toward the center of the downdraft equipment into the filter compartment that houses the filter insert.

A collecting operation 740 collects particulate matter that separates from the dirty air flow before filtering operation 745, discussed below, in one or more removable clean-out trays. The operator may periodically remove the clean-out trays to empty the particulate matter. A filtering operation 745 filters the dirty air within the filter compartment to produce clean air output from the filter compartment. As air moves through the filter insert, particulates in the air attach to the filter insert, thereby cleaning the airflow.

An exhausting operation 750 exhausts the clean air out of the downdraft equipment. In some implementations, an exhaust port is located in a back panel of the downdraft equipment, and air exits out the exhaust port. In other implementations, the exhaust port may be vented out of a different panel of the downdraft equipment (e.g., a bottom panel). The downdraft equipment may include a self-closing louver. The self-closing louver forces the exhausting operation 750 to flow air in a singular direction, thereby precluding particulate from blow-back through the perforated work surface and/or the perforated rear wall.

The logical operations making up the implementations described herein are referred to variously as a method, operations, steps, objects, or modules. Furthermore, the logical operations may be performed in any order, adding or omitting operations as desired, unless explicitly claimed otherwise or a specific order is inherently necessitated by the claim language.

The structure and/or functionality of downdraft tables, air samplers, filter compartments, etc., may differ from that illustrated in FIGS. 1-7 and described herein. For example, the arrangement of the components within the downdraft tables, air samplers, and/or filter compartments are provided for illustration and not of limitation, and some components and/or interconnections may be omitted for clarity. The downdraft tables, air samplers, and/or filter compartments may not include all components or perform all the steps shown in FIGS. 1-7, may include other components/steps not explicitly shown in FIGS. 1-7, or may utilize an architecture or process completely different than that shown in FIGS. 1-7.

The above specification, examples, and data provide a complete description of the structure and use of example implementations of the presently disclosed technology. Since many implementations of the invention can be made without departing from the spirit and scope of the invention, the invention resides in the claims hereinafter appended. Furthermore, structural features of the different implementations may be combined in yet another implementation without departing from the recited claims. The implementations described above, as well as other implementations, are within the scope of the following claims.

What is claimed is:

1. A piece of downdraft equipment comprising:
a perforated surface;
a dirty air intake plenum;
an air sampler including:
a sampler intake with an input in the dirty air intake plenum;
a sample plenum with a sample port; and
a sampler fan, the sampler fan to draw a sample of the dirty air from the sampler intake and discharge the dirty air sample into the sample plenum; and
a filtration fan to draw dirty air from the perforated surface and through the dirty air intake plenum and exhaust filtered air out of the downdraft equipment.

2. The piece of downdraft equipment of claim 1, wherein the air sampler further includes:
a portable air quality detector to removably connect to the sample port, the portable air quality detector to provide a quality metric of the dirty air.

3. The piece of downdraft equipment of claim 2, wherein the quality metric includes a presence of one or more of: pathogens, volatile organic compounds (VOCs), carbon monoxide (CO), poisonous compounds, explosives, or psychoactive drugs, referenced against a threshold.

4. The piece of downdraft equipment of claim 2, further comprising:
a sampler housing including a removable access panel.

5. The piece of downdraft equipment of claim 4, wherein the portable air quality detector is configured to rest on the removable access panel when closed.

6. The piece of downdraft equipment of claim 5, further comprising:
an air sampler tray, wherein a bottom of the air sampler tray is defined by the removable access panel, and a rear of the air sampler tray is defined by the sample plenum.

7. The piece of downdraft equipment of claim 4, wherein the sampler housing further includes a power supply to power one or both of the sampler fan and the portable air quality detector.

8. The piece of downdraft equipment of claim 4, wherein the sampler fan is oriented within the sample plenum, further comprising:
a fan baffle oriented between the sampler fan and the sample port.

9. The piece of downdraft equipment of claim 1, wherein the sampler fan maintains the sample plenum at a positive pressure.

10. The piece of downdraft equipment of claim 1, wherein the sampler intake includes a multi-port intake manifold that extends across the dirty air intake plenum.

11. The piece of downdraft equipment of claim 1, wherein the air sampler further includes:
an indicator light configured to communicate to a user that the sampler fan is running.

12. The piece of downdraft equipment of claim 1, wherein the piece of downdraft equipment is a downdraft table, and wherein the perforated surface is a perforated work surface or a perforated rear wall of the downdraft table.

13. A method of using an air sampler to provide a quality metric of dirty air entering a piece of downdraft equipment comprising:
drawing dirty air from one or both of a perforated work surface and a perforated rear wall of the downdraft equipment, through a dirty air intake plenum, and into a filter compartment using a filtration fan;
sampling dirty air flowing through the dirty air intake plenum at a sampler intake with an input in the dirty air intake plenum using a sampler fan;
discharging the sampled dirty air into a sample plenum with a sample port; and
removably connecting a portable air quality detector to the sample port; and
providing the quality metric of the dirty air using the portable air quality detector.

14. The method of claim 13, wherein the quality metric includes a presence of one or more of: pathogens, volatile organic compounds (VOCs), carbon monoxide (CO), poisonous compounds, explosives, or psychoactive drugs, referenced against a threshold.

15. The method of claim 13, wherein the sampler fan maintains the sample plenum at a positive pressure.

16. The method of claim 13, wherein the sampler intake includes a multi-port intake manifold that extends across a depth of the dirty air intake plenum.

17. The method of claim 13, further comprising:
visually indicating to a user of the downdraft equipment that the sampler fan is running.

18. The method of claim 13, further comprising:
filtering the dirty air within the filter compartment to produce clean air output from the filter compartment; and
exhausting the clean air out of the downdraft equipment.

19. A downdraft table comprising:
a perforated work surface;
a perforated rear wall;
a dirty air intake plenum;
a filter compartment;
an air sampler including:
a sampler intake with an input in the dirty air intake plenum;
a sample plenum with a sample port; and
a sampler fan within the sample plenum, the sampler fan to draw a sample of the dirty air from the sampler intake and discharge the dirty air sample into the sample plenum; and
a filtration fan to draw dirty air from the perforated work surface and the perforated rear wall, through the dirty air intake plenum, and through the filter compartment, the filtration fan further to exhaust filtered air out of the downdraft table.

20. The downdraft table of claim 19, wherein the air sampler further includes:
a portable air quality detector to removably connect to the sample port, the portable air quality detector to provide a quality metric of the dirty air.
